(19) United States
(12) Patent Application Publication
(10) Pub. No.: US 2025/0120532 A1
(43) Pub. Date: Apr. 17, 2025

(54) MOKA COFFEE POT COMPRISING IMPROVED SEALING CHARACTERISTICS

(71) Applicant: Shixian Jin, Burlington, NC (US)

(72) Inventor: Shixian Jin, Burlington, NC (US)

(21) Appl. No.: 18/379,890

(22) Filed: Oct. 13, 2023

(51) Int. Cl. A47J 31/30; A23F 5/26; A47J 31/06

(52) U.S. Cl. CPC A47J 31/303; A23F 5/262; A47J 31/0663

(57) ABSTRACT

The invention is a moka coffee pot apparatus comprising improved sealing characteristics. The moka pot includes a lower water boiling chamber and a brewing insert that extends into the lower chamber and holds an amount of ground coffee. The moka pot also includes an upper chamber for receiving brewed coffee. Advantageously, the moka pot includes first and second attachments and a sealing ring that act as a locking mechanism to provide secure connection between the upper and lower chambers.

### TECHNICAL FIELD

The presently disclosed subject matter is generally directed to a thin plate moka coffee pot that includes improved sealing characteristics. The present disclosure further includes methods of making and using the disclosed moka pot.

### BACKGROUND

A moka pot is a tool for extracting and brewing coffee and other hot beverages. The moka pot was initially popularized in Europe and has gradually expanded such that it is currently used worldwide. As shown in FIG. 1, conventional moka pots include lower compartment 1 that houses a volume of water. The pot is heated by exposing the bottom surface of the lower compartment to a burner, stovetop, or other heat source. The heating of the lower compartment leads to a gradual increase in pressure due to expansion of the enclosed air in the lower compartment and the increased vapor pressure as the water heats. As the pressure increases, water from the lower compartment is forced upwards into funnel 2 and passes through coffee grounds housed within basket 3. Brewed coffee will then fill upper funnel 6 and be deposited into upper chamber 4. Thus, the coffee is brewed by passing hot water driven by vapor pressure through coffee grounds located in basket 3. However, traditional moka coffee pots are made from aluminum alloy components, making the product heavy and inconvenient to carry. In addition, traditional moka pots often experience difficulty with sealing mechanisms, resulting in leaking and/or dripping of water and water vapor. It would therefore be beneficial to provide an improved moka pot that overcomes the shortcomings of the prior art.

### SUMMARY

In some embodiments, the presently disclosed subject matter is directed to a moka pot comprising a lower chamber. The lower chamber includes a body defined by a bottom face operably connected to a sidewall to form an interior with an open top. The lower chamber further includes a first attachment defined by a lower edge secured about an upper circumference of a top edge of the body, one or more grooves or threads positioned adjacent to the body sidewall, and an upper face comprising a horizontal ledge positioned about a circumference of the upper face. The moka pot includes a brewing insert comprising a top edge, opposed bottom edge, and an interior, with a peripheral flange adjacent to the top edge of the brewing insert, wherein the brewing insert is configured to fit within the interior of the lower chamber body. The moka pot comprises a lower pipe positioned within the interior of the lower chamber body, the lower pipe in fluid communication with the lower chamber interior and the brewing insert. The moka pot includes an upper filter positioned within the brewing insert interior adjacent to the top edge and a lower filter positioned within the brewing insert at the bottom edge. The moka pot includes an upper chamber defined by a bottom face operably connected to a sidewall to form an interior with an open top, the upper chamber including a second attachment positioned about a circumference of the upper chamber adjacent to the bottom face and wherein the second attachment includes one or more grooves or threads that releasably attach with the grooves or threads on the first attachment to join the upper and lower chambers. The moka pot comprises an upper pipe positioned within the interior of the upper chamber, the upper pipe comprising an outlet. The moka pot includes a sealing ring positioned between the insert and the lower chamber, wherein the sealing ring and first and second attachments provide a double sealing of the upper and lower chambers.

In some embodiments, the insert interior comprises ground coffee.

In some embodiments, the upper and lower filters are mesh filters.

In some embodiments, at least one of the upper chamber, lower chamber, or insert are constructed from titanium.

In some embodiments, the insert includes a safety vent to vent excess pressure from the interior of the lower chamber.

In some embodiments, the upper pipe includes an upper anti-splash dome.

In some embodiments, the moka pot includes a recess formed between the lower face of the upper chamber and the upper face of the insert.

In some embodiments, the moka pot includes a removable lid.

In some embodiments, the first and second attachments are attached to the lower and upper chambers via welding.

In some embodiments, the moka pot includes a handle, which can be a foldable handle.

In some embodiments, at least one of the upper chamber, lower chamber, insert have a thickness of about 0.01-0.1 inches.

In some embodiments, the presently disclosed subject matter is directed to a method of preparing a brewed beverage. Particularly, the method comprises adding a volume of liquid to the interior of the lower chamber of the disclosed moka pot. The method includes adding a material to be brewed to the interior of the insert, and positioning the insert within the interior of the lower chamber such that the insert flange rests on the first attachment ledge. The method comprises securing the upper chamber above the lower chamber via cooperation between the first and second attachment grooves or threads, thereby creating a sealed unit, and positioning the lower chamber adjacent to a heat source. The heat increases the pressure within the lower chamber interior, forcing water into the lower pipe, through the lower filter, through the interior of the insert, through the upper filter, and upward through the upper pipe to into the interior of the upper chamber as a brewed liquid.

In some embodiments, the brewed liquid is coffee.

In some embodiments, excess pressure within the lower chamber is vented via a safety vent in the insert.

In some embodiments, the liquid passes through a recess formed between the lower face of the upper chamber and the upper face of the insert prior to entering the upper pipe.

In some embodiments, the material to be brewed is coffee grounds.

In some embodiments, the lower and/or upper chamber interior has a volume of about 1-5 cups or more.

In some embodiments, the brewed liquid is dispensed from the upper chamber.

In some embodiments, the brewed liquid is dispensed using a foldable handle.

### BRIEF DESCRIPTION OF THE DRAWINGS

FIG. 1 is a cross-sectional view of one example of a prior art moka pot.

FIG. 2 is a cross-sectional view of a moka pot in accordance with some embodiments of the presently disclosed subject matter.

FIG. 3a is a front plan view of a moka pot lower chamber in accordance with some embodiments of the presently disclosed subject matter.

FIG. 3b is a cross-sectional view of a moka pot lower chamber in accordance with some embodiments of the presently disclosed subject matter.

FIG. 3c is a perspective view of a lower chamber body in accordance with some embodiments of the presently disclosed subject matter.

FIG. 3d is a fragmentary cross-sectional view of a moka pot lower chamber attachment in accordance with some embodiments of the presently disclosed subject matter.

FIG. 4a is a cross-sectional view of a moka pot funnel in accordance with some embodiments of the presently disclosed subject matter.

FIG. 4b is a top plan view of a filter in accordance with some embodiments of the presently disclosed subject matter.

FIG. 4c is a cross-sectional view of a moka pot filter positioned in a lower chamber in accordance with some embodiments of the presently disclosed subject matter.

FIG. 5 is a cross-sectional view of a moka pot in use in accordance with some embodiments of the presently disclosed subject matter.

FIG. 6 is a cross-sectional view of a moka pot upper chamber in accordance with some embodiments of the presently disclosed subject matter.

FIG. 7 is a fragmentary cross-sectional view of an upper and lower chamber sealing attachment in accordance with some embodiments of the presently disclosed subject matter.

FIG. 8 is a cross-sectional view of a moka pot handle in accordance with some embodiments of the presently disclosed subject matter.

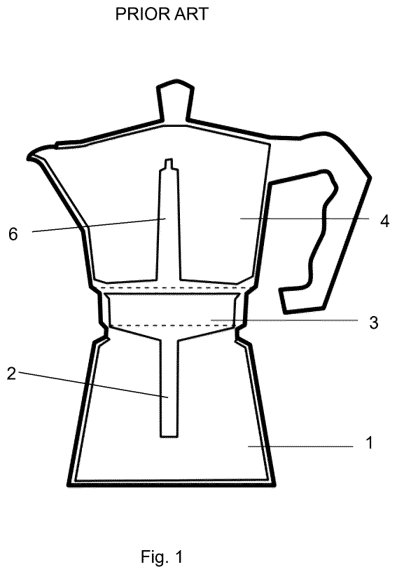

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

As used herein, the term “and/or” includes any and all combinations of one or more of the associated listed items.

Relative terms such as “below” or “above” or “upper” or “lower” or “horizontal” or “vertical” may be used herein to describe a relationship of one element, layer, or region to another element, layer, or region as illustrated in the drawing figures. It will be understood that these terms and those discussed above are intended to encompass different orientations of the device in addition to the orientation depicted in the drawing figures.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

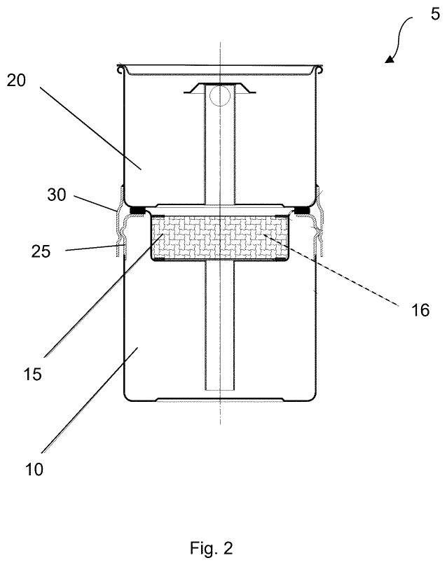

The presently disclosed subject matter is directed to a moka coffee pot apparatus comprising improved sealing characteristics. The term “moka coffee pot” refers to a stovetop or electric coffee maker that brews coffee by passing hot water driven by vapor pressure through ground coffee. FIG. 2 illustrates one embodiment of disclosed moka coffee pot 5. As shown, the moka pot includes a lower water boiling chamber 10 and brewing insert 15 that extends into the lower chamber and holds an amount of ground coffee 16. The moka pot also includes upper chamber 20 for receiving brewed coffee. Advantageously, the moka pot includes first and second attachments 25, 30 that act as a locking mechanism to provide secure connection between the upper and lower chambers. As disclosed in detail below, as water in lower chamber 10 is heated and boiled, it is forced under pressure up a lower tube, through coffee grounds 16 in the brewing insert, and into the upper chamber to produce coffee. The coffee can then be dispensed from the upper chamber.

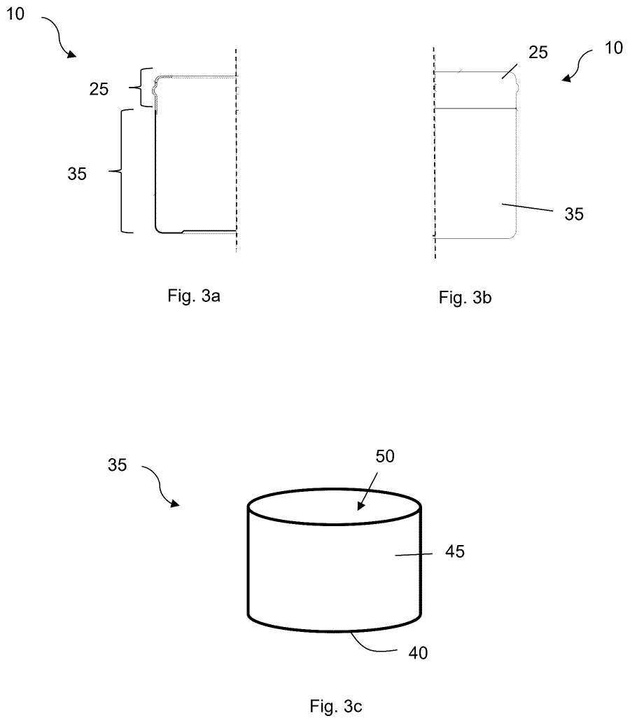

As noted above, moka pot 5 includes lower chamber 10 configured to house a volume of water to be heated for brewing coffee. FIGS. 3a and 3b illustrate one embodiment of the lower chamber comprising body 35 and first attachment 25 secured to a top circumference of the body (e.g., the attachment is secured along the entire top edge of the body). The attachment and body can be secured together using any known mechanism, such as (but not limited to) the use of welding, adhesives, thermoforming, and the like.

The lower chamber body can be configured as a cylindrical container, as shown in FIG. 3c. Particularly, lower chamber body 35 can include lower face 40 operably connected to one or more sidewalls 45 to create an interior and open top 50. In some embodiments, lower face 40 can be configured as a horizontal face to allow the lower chamber to rest on a support surface, such as a table or the floor. It should be appreciated that the lower chamber can be configured in any desired shape and is not limited to the cylindrical shape of FIG. 3c.

Lower chamber body 35 can house any suitable volume of water (or any liquid), such as about 0.25-5 cups or more (e.g., at least/no more than about 0.25, 0.5, 0.75, 1, 2, 3, 4, or 5 cups). However, the presently disclosed subject matter is not limited and the lower chamber body can be sized to house any desired volume of water.

As shown in FIG. 3d, first attachment 25 is joined around the top edge of the lower chamber body 35 and includes one or more grooves or threads 55 that enable the upper and lower chambers to be releasably attached together. The first attachment also includes horizontal ledge 60 configured about the perimeter of the top face of the attachment that provides support for the brewing insert. The attachment comprises central opening 65 that further accommodates the insert, allowing it to be housed within the lower chamber as discussed below. It should be appreciated that ledge 60 surrounds the central opening of the first attachment.

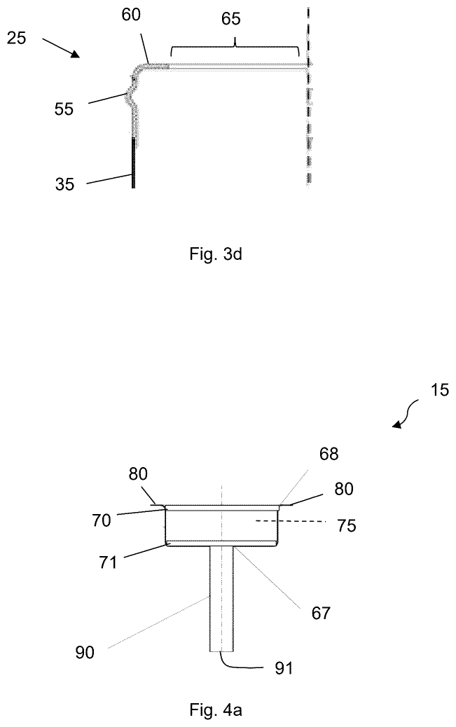

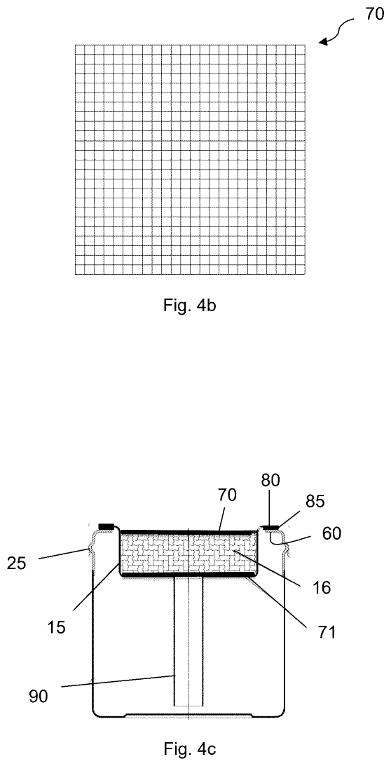

Moka pot 5 also includes brewing insert 15 that holds ground coffee 16 or any other desired material (e.g., tea leaves and the like). FIG. 4a illustrates one embodiment of insert 15 comprising upper and lower filters 70, 71 positioned to span the upper and lower faces of filter housing 72. The term “filter” refers to a porous component through which fluid can pass, but that traps one or more materials (e.g., coffee grounds) present within the fluid. Filters 70, 71 can be constructed from any suitable materials. For example, in some embodiments, the filters can be mesh filters, as shown in FIG. 4b. The term “mesh” refers to a semi-permeable layer with material present in a grid, web, or crossed arrangement. Filters 70, 71 can have any suitable shape and size to ensure that water passing from the lower chamber to the upper chamber is filtered such that coffee grounds 16 remain within the funnel interior. It should be appreciated that the shape of the filters correspond to the cross-sectional shape of the insert at the upper and lower faces of the insert. Upper filter 70 therefore retains a charge of coffee grounds 16 to prevent the grounds from being carried into the upper chamber.

The filters can be retained within insert 15 using any conventional method, such as the use of magnets, clip-in attachment, screws, bolts, and the like. In some embodiments, the filters can be removable from the brewing insert, thereby allowing for easy replacement and/or cleaning.

Insert 15 also includes interior compartment 75 that houses a volume of ground coffee (or any other desired material). The insert can hold any volume of material, such about 1-5 teaspoons to about 0.1-1 cup. It should be appreciated that the insert is not limited and can be configured in any suitable size or shape so long as the body of the insert can be configured within the interior of the lower chamber.

The brewing insert further includes peripheral flange 80 that is sized and shaped to rest upon and be supported by ledge 60 of the insert. The flange is thus configured as an overhang that surrounds the entire circumferential edge of the insert about the insert top edge, allowing the insert to rest on the ledge 60 of the attachment of the lower chamber. In addition, sealing ring 85 (which can be configured as an o-ring in some embodiments) further ensures that the arms of the insert remain in proper position on the first attachment of the lower chamber, as well as provide an airtight seal between the upper and lower chambers. Stated another way, the sealing ring is positioned between the insert flange and the first attachment ledge to ensure no leaks occur. The sealing ring can be constructed from any suitable material, such as rubber, silicone, and the like. As shown in FIG. 4c, the brewing insert can be positioned within the interior of lower chamber 35 through the central opening 65 of attachment 25 and suspended and support on the lower attachment ledge via peripheral flange 80.

The disclosed system further includes lower pipe 90 extending in a downward direction from the brewing insert, directly adjacent to lower filter 71. The lower pipe is in fluid communication with the interior of the lower chamber and the brewing insert interior. The term “pipe” refers to any conduit through which a fluid can be moved. Thus, the pipe includes open distal end 91 through which water can flow from the lower chamber interior to the insert interior.

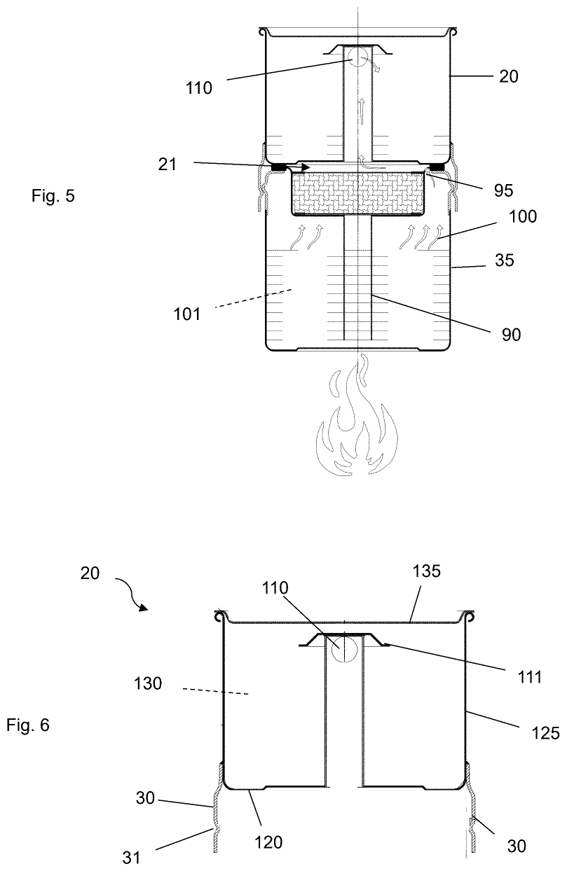

Insert 15 further includes safety vent aperture 95 that serves as a pressure relief vent. As shown in FIG. 5, the aperture is positioned within or adjacent to the peripheral flange. Thus, when the pressure inside lower chamber 35 is too high, steam 100 produced from heated water 101 can pass through the aperture into upper pipe 105 to exit the apparatus at upper pipe exit 110 as illustrated by the arrows, thereby preventing excessive pressure in the lower chamber.

The calculation and design of the vent aperture is based on the volume and production efficiency of the coffee pot, as well as the pressure generated during use. The aperture ensures that the presence of the small hole does not cause the pressure inside the lower cup body to be too low, preventing the steam or hot water from properly passing through the coffee powder into the upper cup body. It also prevents excessive pressure build-up in the lower cup body when rapidly heated, as the high pressure would release the steam directly through the small hole. The vent hole can prevent unsafe situations due to excessive pressure in the lower cup body. The overall safety design ensures a safe pressure relief pathway when pressure is too high.

As shown, upper pipe 105 (in fluid communication with lower pipe 90 and the insert) is also housed within the interior of the upper chamber. As noted above, the upper pipe includes outlet 110 through which brewed coffee can exit the pipe and be deposited and stored within the upper compartment interior. Anti-splash dome 111 ensures that no coffee is spilled unnecessarily.

FIG. 6 illustrates one embodiment of upper chamber 20. As shown, the upper chamber includes lower face 120 that is positioned adjacent to the top surface of brewing insert 15. The upper chamber also includes at least one sidewall 125 connected to the lower face to form interior 130.

As shown in FIG. 6, recess 21 is formed between the upper and lower chambers and the upper chamber and insert 15. The recess allows for efficient flow of water vapor from the lower chamber through vent aperture 95 and allows water to exit the inert to the upper chamber into the upper pipe. The recess further allows the upper mesh filter to be separated from the upper chamber body, providing a larger filtration area for steam and hot water. As a result, pressure buildup is avoided in the lower chamber. A clear path for pressure relief is thus provided through safety aperture 95, ensuring safe use of moka pot 5.

The upper chamber also includes lid 135 that can be releasably secured about the circumference of the top edge(s) of sidewall 125. Advantageously, the removable lid allows a user to pour a desired amount of brewed coffee. The lid also protects the interior of the upper chamber from environmental hazards, such as rain, dirt, and the like.

The upper chamber can have any desired volume, such as about 0.25-5 cups (e.g., at least/no more than about 0.25, 0.5, 0.75, 1, 2, 3, 4, or 5 cups). However, the presently disclosed subject matter is not limited and the upper chamber can be sized to house any desired volume of water.

The upper chamber also includes second attachment 30 that extends about the outer perimeter of the upper chamber, adjacent to lower face 120. As illustrated, the second attachment includes one or more grooves or threads 31 that are sized and shaped to cooperate with the corresponding grooves or threads on first attachment 25. In this way, the upper and lower chambers can be releasably attached together, thereby avoiding or reducing the amount of spillage and securely attached the upper and lower chambers together.

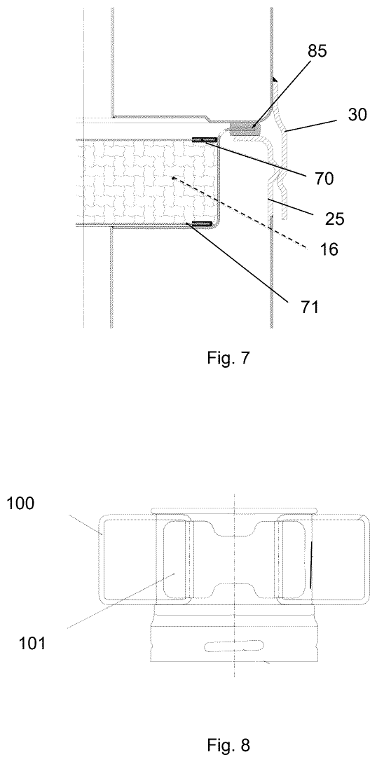

Thus, sealing ring 85 of the insert and the first and second attachments 25, 30 form two layers of sealing. The sealing ring forms a sealing surface between the edge plane of the insert and the plane of the lower chamber body, as well as between the edge plane of the insert and the bottom surface of the upper chamber body. When the attachment threads 55 and 31 of the first and second attachments are tightened, both surfaces are sealed at the same time. The structure of moka pot 5 therefore ensures self-alignment, preventing the sealing ring from being pressed against other components during deformation and causing leakage, as shown in FIG. 7.

The second attachment can be attached about the outer perimeter of the upper chamber using welding, adhesives, thermoforming, and the like. Any suitable mechanism can be used.

In some embodiments, the moka pot can include a handle 100 welded or otherwise attached to the upper or lower chamber. In some embodiments, the handle includes securing element 101 that fastens the handle in place when the handle is configured to be foldable (e.g., extends for use and folds inward when not needed). Advantageously, a folded handle allows the disclosed moka coffee pot apparatus to have a compact size for portability.

The upper chamber, lower chamber, and/or pipes can be constructed from any suitable material, such as ceramics or metal (e.g., stainless steel). In some embodiments, one or more lightweight materials can be used to construct one or more elements of the coffee pot, such as titanium. As a result, the pot can be lightweight and easily portable.

The materials used to construct the disclosed moka pot can be thin, having a thickness of about 0.01, 0.05, 0.1, 0.25, 0.5 inches.

In use, a desired amount of water (or any suitable liquid) is added into the interior of the lower chamber. A desired amount of ground coffee 16 (or any desired material) is then added to the interior of brewing insert 15. The brewing insert is added to the pot such that the body of the insert and the lower pipe extend into the interior of the lower chamber. As noted above, the insert flange is supported by and rests upon the ledge of the first attachment. The upper chamber is then attached via connection by the first and second attachments to the lower chamber (e.g., screw thread attachment or any other releasable mechanism). A heating element is put into operation beneath the bottom face of the lower chamber, which heats the water in the lower chamber. When the water comes to a boil, it is forced (owing to the pressure that is developed in response to the heat) through the lower pipe into the interior of the brewing insert where it contacts the ground coffee to form liquid coffee. The produced liquid then is filtered by upper filter 70 which retains grounds 16. The liquid coffee rises through the upper pipe and escapes through the outlet 110 into the upper chamber interior. A user may pour out the coffee for drinking through the upper chamber.

The disclosed pot 5 offers many advantages over prior art moka pots. For example, the disclosed pot has an optimal extraction rate to promote properly brewed coffee.

The moka pot can be constructed from food safe and lightweight materials, which make the pot convenient and easy to carry.

In addition to coffee, the disclosed moka pot can be used to produce any suitable beverage, such as herbal tea, herbal tinctures, and the like.

The disclosed moka pot includes the first attachment precisely welded or otherwise attached to the lower chamber body at an optimal position to ensure no leakage occurs.

Therefore, disclosed moka pot can be constructed from titanium thin plates, aiming to utilize the health benefits and lightweight, high-strength properties of titanium to achieve a coffee pot that is made of healthy materials and easy to carry.

The inclusion of the vent aperture allows steam to pass into the upper pipe in the upper cup body, then to the atmosphere, preventing excessive pressure in the lower chamber. As a result, moka pot 5 includes improved safety features.

The disclosed pot offers a unique double sealing advantage. The sealing ring of the brewing insert forms two layers of sealing. The ring forms a sealing surface between the edge plane of the insert and the plane of the lower chamber body, as well as between the edge plane of the insert and the bottom surface of the upper chamber body. When the attachment threads are tightened, both surfaces are sealed at the same time. The design of the ring ensures self-alignment, preventing the ring from being pressed against other components during deformation and causing leakage.

The disclosed pot can include a foldable handle that enables a compact size for portability.

The design of the recess in the upper chamber body allows the upper filter to be separated from the upper chamber body, providing a larger filtration area for steam and hot water. This avoids pressure build-up in the lower chamber and provides a clear path for pressure relief through the safety vent, ensuring the safety of using the moka pot.

All or a portion of the disclosed coffee pot can be designed using thin plate deep press and precise welding, making the coffee pot lightweight and portable.

The design of the sealing ring ensures that it is concentric with the insert, and the insert is naturally concentric with the lower chamber, preventing the deformation of the sealing during compression and interference with other components, resulting in leakage. The dual-side sealing structure of the sealing ring is simpler and more reliable compared to conventional moka pots.

The moka pot thus being described, it will be obvious that the same may be varied in many ways. Such variations are not to be regarded as a departure from the spirit and scope of the disclosure, and all such modifications as would be obvious to one skilled in the art are intended to be included within the scope of the following claims.

What is claimed is:

1. A moka pot comprising:
a lower chamber comprising:
a body defined by a bottom face operably connected to a sidewall to form an interior with an open top;
a first attachment defined by a lower edge secured about an upper circumference of a top edge of the body, one or more grooves or threads positioned adjacent to the body sidewall, and an upper face comprising a horizontal ledge positioned about a circumference of the upper face;
a brewing insert comprising a top edge, opposed bottom edge, and an interior, with a peripheral flange adjacent to the top edge of the brewing insert, wherein the brewing insert is configured to fit within the interior of the lower chamber body;
a lower pipe positioned within the interior of the lower chamber body, the lower pipe in fluid communication with the lower chamber interior and the brewing insert;
an upper filter positioned within the brewing insert interior adjacent to the top edge and a lower filter positioned within the brewing insert at the bottom edge;
an upper chamber defined by a bottom face operably connected to a sidewall to form an interior with an open top, the upper chamber including a second attachment positioned about a circumference of the upper chamber adjacent to the bottom face and wherein the second attachment includes one or more grooves or threads that releasably attach with the grooves or threads on the first attachment to join the upper and lower chambers;
an upper pipe positioned within the interior of the upper chamber, the upper pipe comprising an outlet;
a sealing ring positioned between the insert and the lower chamber;
wherein the sealing ring and first and second attachments provide a double sealing of the upper and lower chambers.

2. The moka pot of claim 1, wherein the insert interior comprises ground coffee.

3. The moka pot of claim 1, wherein the upper and lower filters are mesh filters.

4. The moka pot of claim 1, wherein at least one of the upper chamber, lower chamber, or insert are constructed from titanium.

5. The moka pot of claim 1, wherein the insert includes a safety vent to vent excess pressure from the interior of the lower chamber.

6. The moka pot of claim 1, wherein the upper pipe includes an upper anti-splash dome.

7. The moka pot of claim 1, comprising a recess formed between the lower face of the upper chamber and the upper face of the insert.

8. The moka pot of claim 1, further comprising a removable lid.

9. The moka pot of claim 1, wherein the first and second attachments are attached to the lower and upper chambers via welding.

10. The moka pot of claim 1, further including a handle.

11. The moka pot of claim 10, wherein the handle is foldable.

12. The moka pot of claim 1, wherein at least one of the upper chamber, lower chamber, insert have a thickness of about 0.01-0.1 inches.

13. A method of preparing a brewed beverage, the method comprising:
adding a volume of liquid to the interior of the lower chamber of the moka pot of claim 1;
adding a material to be brewed to the interior of the insert;
positioning the insert within the interior of the lower chamber such that the insert flange rests on the first attachment ledge;
securing the upper chamber above the lower chamber via cooperation between the first and second attachment grooves or threads, thereby creating a sealed unit;
positioning the lower chamber adjacent to a heat source;
wherein the heat increases the pressure within the lower chamber interior, forcing water into the lower pipe, through the lower filter, through the interior of the insert, through the upper filter, and upward through the upper pipe to into the interior of the upper chamber as a brewed liquid.

14. The method of claim 13, wherein the brewed liquid is coffee.

15. The method of claim 13, wherein excess pressure within the lower chamber is vented via a safety vent in the insert.

16. The method of claim 13, wherein the liquid passes through a recess formed between the lower face of the upper chamber and the upper face of the insert prior to entering the upper pipe.

17. The method of claim 13, wherein the material to be brewed is coffee grounds.

18. The method of claim 13, wherein the lower chamber interior, upper chamber interior, or both has a volume of about 1-5 cups or more.

19. The method of claim 1, wherein the brewed liquid is dispensed from the upper chamber.

20. The method of claim 1, wherein the brewed liquid is dispensed using a foldable handle.
